(19) United States
(12) Patent Application Publication
(10) Pub. No.: US 2018/0351776 A1
(43) Pub. Date: Dec. 6, 2018

(54) METHOD AND SYSTEM FOR DEMODULATING HIGH-ORDER QAM SIGNALS

(71) Applicants: ZTE Wistron Telecom AB, Kista Science Tower (SE); ZTE (TX) INC,, Austin, TX (US)

(72) Inventors: Aijun CAO, Kista (SE); Juquan MAO, Kista (SE); Mhamoud Alfa ABDULLAHI, Kista (SE); Pei XIAO, Kista (SE); Yonghong GAO, Kista (SE); Jan JOHANSSON, Kista (SE)

(21) Appl. No.: 15/779,059

(22) PCT Filed: Dec. 1, 2016
(86) PCT No.: PCT/US2016/064488

§ 371 Date: May 24, 2018

Related U.S. Application Data
(60) Provisional application No. 62/262,472, filed on Dec. 3, 2015.

(51) Int. Cl. H04L 27/38; H04L 27/26; H04L 25/06

(52) U.S. Cl. CPC H04L 27/38; H04L 27/265; H04L 25/067; H04L 27/2607; H04L 27/2653

(57) ABSTRACT

A method and system for demodulating high-order Quadrature Amplitude Modulation (QAM) signals is disclosed. In one embodiment, the system includes a cyclic prefix (CP) removal unit for removing a CP from a received signal to provide a first intermediate signal, wherein the first intermediate signal comprises a plurality of bits; a fast Fourier transform (FFT) unit configured to convert the first intermediate signal into a frequency domain; a soft de-mapper configured to derive a plurality of soft bits based on log-likelihood estimates of the plurality of bits, wherein the soft de-mapper derives each soft bit by using a single linear function to approximate each soft bit; and a decoder configured to decode a signal derived from the soft de-mapper into information.

### FIELD OF THE INVENTION

The invention is directed to methods and systems for demodulating high-order QAM (Quadrature Amplitude Modulation) signals used in telecommunication systems.

### BACKGROUND

After several decades of evolution, e.g., from 2G, 3G and 4G, and now approaching 5G, the current mobile networks are able to provide billions of mobile users with data transmission service via almost ubiquitous radio access. Network densification is one method for this purpose, in which handsets may have shorter distance to base stations, thus less path-loss of transmitted radio signals. Another method is the use of massive multiple antennas, which means more focused directional transmission of radio signals. And a further method is the use of millimeter waves, which also means shorter and more focused directional transmission of radio signals. All of these methods potentially enable the use of higher-order modulation schemes, e.g., from 64 QAM to 256 QAM.

Modulations with large constellation size have higher date rates for a given signal bandwidth, but they are more susceptible to noise, fading, which need more powerful decoding techniques to mitigate this effect. It has been shown that soft-decision decoding outperforms hard decision decoding by many researchers. A soft-decision decoder requires soft bits as input, which is normally generated by a soft de-mapper, whose function is to convert a received signal into soft bits input to soft input decoders.

It is noteworthy that besides converting the received signal into soft bits, there is also one simpler way of converting the received signal into hard values, which means only the sign of the received signal are taken. But this degrades the achievable decoding performance afterwards.

One conventional method for converting the received signal into soft bits is the so-called Max-Log-Map principle, which means that for each soft bit, it is the log likelihood ratio of a priori probabilities between bit 0 and bit 1 calculated according to the constellation diagram of the modulation scheme. This calculation is very complex and computation intensive.

### SUMMARY OF THE INVENTION

In accordance with various embodiments, a soft de-mapper will be described for 256 QAM based on an orthogonal frequency division multiplexing (OFDM) system model, which is currently implemented in LTE. It is understood, however, that the invention can also be applied to any other non-OFDM based system in accordance with various alternative embodiments of the invention.

In one embodiment, the invention provides a low-complexity and superior-performance soft demapper for higher-order, e.g., 256 QAM, which facilitates soft-input decoders in future wireless system.

### BRIEF DESCRIPTION OF THE DRAWING

FIG. 1 illustrates an OFDM system implementation of multiracial modulation, in accordance with various embodiments of the invention.

FIG. 2 illustrates a two-dimensional 256-QAM constellation in accordance with various embodiments.

FIG. 3 illustrates a one-dimensional 256-QAM constellation in accordance with various embodiments.

FIG. 4 illustrates graphs of an approximated function of λ(c₀) versus a piecewise function of λ(c₀), in accordance with various embodiments.

FIG. 5 shows the performance comparison of a hard demapper to that of the soft demapper for a 256-QAM system, in accordance with some embodiments.

### DETAILED DESCRIPTION OF EXEMPLARY EMBODIMENTS

The following disclosure describes various exemplary embodiments for implementing different features of the subject matter. Specific examples of components and arrangements are described below to simplify the present disclosure. These are, of course, merely examples and are not intended to be limiting.

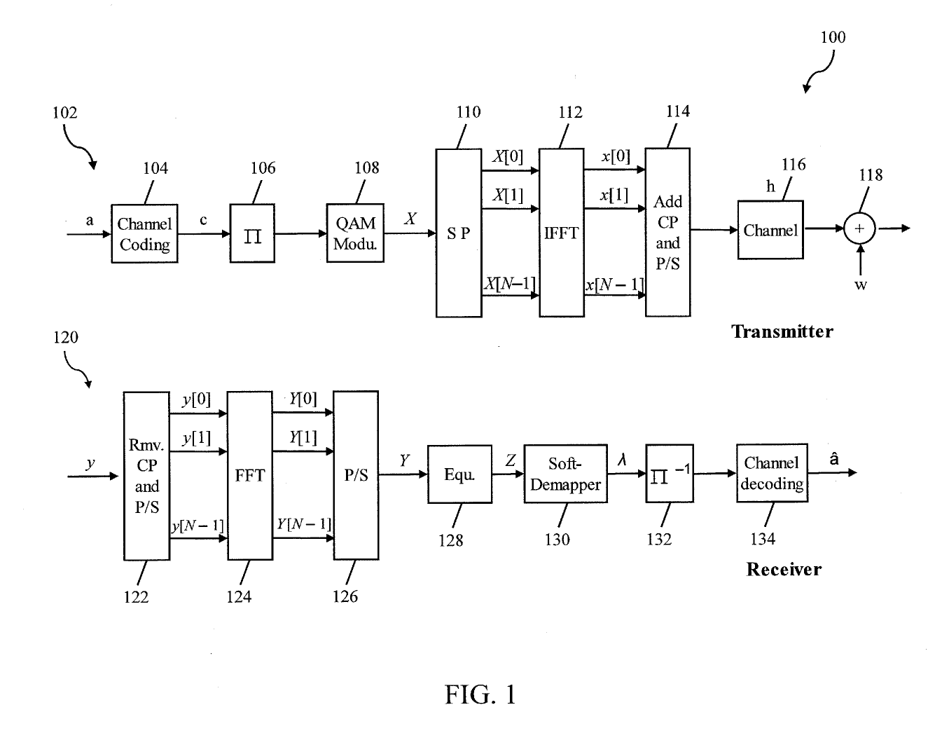

FIG. 1, illustrates an OFDM system implementation of multiracial modulation, in accordance with one embodiment of the invention. The OFDM system 100 includes a transmitter chain 102 and receiver chain 120. In the transmitter chain 102, an input data steam {a(n)} is encoded by a channel coding unit 104 into a coded bit sequence {c(n)} which is interleaved by an interleaving unit 106 and then modulated by a QAM modulator 108, resulting in a complex symbol stream X[0],X[1], . . . , X[N]. This symbol stream is passed through a serial-to-parallel converter 110, whose output is a set of N parallel QAM symbols X[0],X[1], . . . , X[N−1]. These N parallel symbols are imposed onto orthogonal sub-carriers through inverse fast Fourier transform (IFFT) unit 112, which yields the OFDM symbol consisting of the sequence x[0], x[1], . . . , x[N−1] in the time domain. A cyclic prefix (CP) is then added to the OFDM symbol for transmission by CP unit 114. In some embodiments, the length of the CP is assumed to be longer than the impulse response of the channel to combat Inter-Symbol Interference (ISI). The OFDM signal is then transmitted and filtered by the channel impulse response unit 116 and corrupted by additive noise (w) by adder 118, resulting in a transmitted signal which corresponds to a symbol sequence {y(n)} that is received by the receiver chain 120.

At the receiver chain 120, the CP is removed from the OFDM symbol by CP removal unit 122, and then a fast Fourier transform (FFT) is performed by FFT unit 124 to convert the signal back to the frequency domain, leading to a deformed version of the original symbols. The output of the FFT unit 124, y[1], y[2], . . . , y[n], is parallel-to-serial converted by PIS converter 126 and then passed through a one-tap equalizer 128 to mitigate the channel effect. The output of the equalizer 128 is fed into a soft de-mapper 130 to derive soft estimates of the transmitted bits which are subsequently de-interleaved by de-interleaver 132 and decoded by channel decoder 134 to recover the information bit. The invention provides low-complexity soft de-mapping algorithms for 256-QAM which can benefit future wireless network digital modulation implementations, in accordance with various embodiments of the invention.

Referring still to FIG. 1, in one embodiment of the invention, the symbol received at the k^{th} subcarrier after removing the CP and performing a FFT can be expressed as

Y(k)=X(k)H(k)+W(k),

where H(k) is the channel frequency response (CFR) at the k^{th} subcarrier, Y(k) is the k^{th} sample of the received OFDM symbol, X(k) is the k^{th} sample of the transmitted symbol, and W(k) is the complex additive white Gaussian noise (AWGN) with variance σ₀². After performing a zero-forcing (ZF) frequency equalization and phase correction, one can obtain the following expressions:

$$\begin{matrix}\begin{matrix}Z ( k ) = Y ( k ) \text{/} H ( k ) \\ = X ( k ) + W ( k ) \text{/} H ( k ) \\ = X ( k ) + V ( k ) ,\end{matrix} & ( 1 )\end{matrix}$$

Where V(k) is the complex AWGN with variance σ²=σ₀²/|H (k)|². In the case of 256-QAM modulation, the complex symbols X(k)=aᵣ+jaᵢ takes on values of aᵣ={±A±3A±5A±7A±9A±11A±13A}; aᵢ={±A±3A±5A±7A±9A±11A±13A}; where the normalisation factor A=1/\sqrt{170} is chosen to keep the average symbol power at unity.

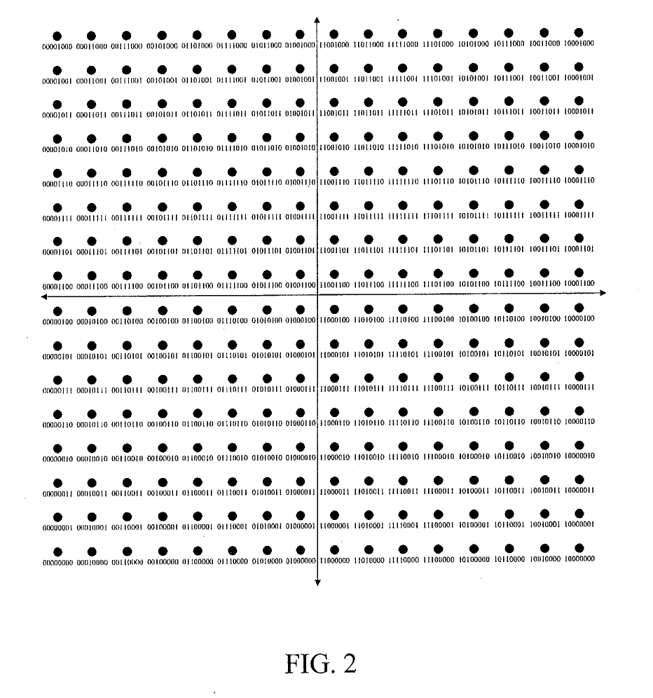

As shown in FIG. 2, in a two-dimensional 256-QAM constellation, each symbol matches eight bits c₀, c₁, c₂, c₃, c₄, c₅, c₆, c₇. In what follows, we derive soft estimates of the transmitted bits to enable soft-input decoding. Since V(k) in (1) is a Gaussian random variable with zero mean and variance σ², the conditional probability density function (PDF) of Z(k) can be derived as

$$\begin{matrix}\begin{matrix}p ( Z ) = \frac{1}{\sqrt{2 π} σ} exp ( - \frac{{\vert Y ( k ) - H ( k ) X ( k ) \vert}^{2}}{2 {σ}^{2}} ) \\ = \frac{1}{\sqrt{2 π} σ} exp ( - \frac{{\vert {H}_{k} \vert}^{2} {\vert Z ( k ) - X ( k ) \vert}^{2}}{2 {σ}^{2}} ) .\end{matrix} & ( 2 )\end{matrix}$$

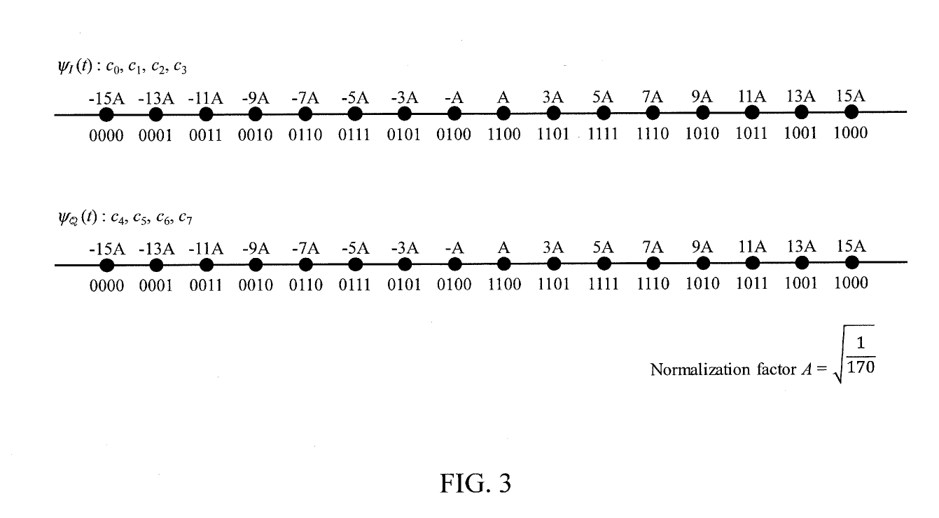

Let us denote Z(k)=Zᵣ+jZᵢ. It can be seen from the FIG. 1 block diagram of the coded OFDM system model that the first four bits c₀, c₁, c₂, c₃ are only associated to the real part Zᵣ while the remaining four bits c₄, c₅, c₆, c₇ are only relevant to the imaginary part Zᵢ. The two dimensional constellation shown in FIG. 2 can be then reduced to a one-dimensional constellation as shown in FIG. 3.

As shown in FIG. 3, four coding bits are associated to each dimension, in accordance with various embodiments. Soft information with reference to Log-likelihood ratio (LLR) indicates the confidence of the decision. According to some embodiments, the soft bit information of the i^{th} coding bit is expressed as follows:

$$LLR ( {c}_{i} ) = ln ( \frac{p ( {Z}_{r} \vert {c}_{i} = 1 )}{p ( {Z}_{r} \vert {c}_{i} = 0 )} ) . \qquad ( 3 )$$

In accordance with some embodiments, the soft information of the first bit c₀ is derived, since the first bit is only relevant to In-phase dimension as illustrated in the FIG. 3, when Zᵣ ∈−{A, 3A, . . . , 15A}, c₀ maps to 0, while when Zᵣ ∈ {A3A, . . . , 15A} c₀ maps to 1. Therefore, the LLR value of c₀ can be further derived from equations (2) (3) into the following equation:

$$LLR ( {c}_{0} ) = ln \frac{{\sum }_{i = 1}^{8} exp [ - {\vert {H}_{k} \vert}^{2} {( {Z}_{r} - ( 2 i - 1 ) A )}^{2} \text{/} 2 {σ}^{2} ]}{{\sum }_{i = 1}^{8} exp [ - {\vert {H}_{k} \vert}^{2} {( {Z}_{r} - ( 2 i - 1 ) A )}^{2} \text{/} 2 {σ}^{2} ]} . \qquad ( 4 )$$

The above equation (4) is complex due to the fact that there are eight terms in both numerator and denominator. A sub-optimal simplified LLR value can be obtained by the approach of log-sum-exponential approximation provided by: log Σᵢexp(φᵢ)=maxᵢ(φᵢ) which enables finding one dominant term in the numerator or denominator by taking the nearest points in the one dimensional constellation. Thus, the equation (4) can be approximated as:

$$\begin{matrix}LLR ( {c}_{0} ) \approx ln \frac{max \{ exp [ - {\vert {H}_{k} \vert}^{2} {( {Z}_{r} - ( 2 i - 1 ) A )}^{2} \text{/} 2 {σ}^{2} ] \}}{max \{ exp [ - {\vert {H}_{k} \vert}^{2} {( {Z}_{r} + ( 2 i - 1 ) A )}^{2} \text{/} 2 {σ}^{2} ] \}} . \\ = {\vert {H}_{k} \vert}^{2} ln \frac{max \{ exp [ - {( {Z}_{r} - ( 2 i - 1 ) A )}^{2} \text{/} 2 {σ}^{2} ] \}}{max \{ exp [ - {( {Z}_{r} + ( 2 i - 1 ) A )}^{2} \text{/} 2 {σ}^{2} ] \}} . \\ = {\vert {H}_{k} \vert}^{2} λ ( {c}_{0} ) . where \\ λ ( {c}_{0} ) \approx ln \frac{max \{ exp [ - {( {Z}_{r} - ( 2 i - 1 ) A )}^{2} \text{/} 2 {σ}^{2} ] \}}{max \{ exp [ - {( {Z}_{r} + ( 2 i - 1 ) A )}^{2} \text{/} 2 {σ}^{2} ] \}}\end{matrix} \qquad ( 5 )$$

With Zᵣ falls into different interval of x-axis, λ(c0) can be written as a piecewise function of Zᵣ

$$\begin{matrix}When {Z}_{r} < - 14 A λ ( {c}_{0} ) \approx ln \frac{exp [ - {( {Z}_{r} - A )}^{2} \text{/} 2 {σ}^{2} ]}{exp [ - {( {Z}_{r} + 15 A )}^{2} \text{/} 2 {σ}^{2} ]} = \frac{2 A}{{σ}^{2}} 8 ( {Z}_{r} + 7 A ) . & ( 6 ) \\ When - 14 A \leq {Z}_{r} < - 12 A λ ( {c}_{0} ) \approx ln \frac{exp [ - {( {Z}_{r} - A )}^{2} \text{/} 2 {σ}^{2} ]}{exp [ - {( {Z}_{r} + 13 A )}^{2} \text{/} 2 {σ}^{2} ]} = \frac{2 A}{{σ}^{2}} 7 ( {Z}_{r} + 6 A ) . & ( 7 ) \\ When - 12 A \leq {Z}_{r} < - 10 A λ ( {c}_{0} ) \approx ln \frac{exp [ - {( {Z}_{r} - A )}^{2} \text{/} 2 {σ}^{2} ]}{exp [ - {( {Z}_{r} + 11 A )}^{2} \text{/} 2 {σ}^{2} ]} = \frac{2 A}{{σ}^{2}} 6 ( {Z}_{r} + 5 A ) . & ( 8 ) \\ When - 10 A \leq {Z}_{r} < - 8 A λ ( {c}_{0} ) \approx ln \frac{exp [ - {( {Z}_{r} - A )}^{2} \text{/} 2 {σ}^{2} ]}{exp [ - {( {Z}_{r} + 9 A )}^{2} \text{/} 2 {σ}^{2} ]} = \frac{2 A}{{σ}^{2}} 5 ( {Z}_{r} + 4 A ) . & ( 9 ) \\ When - 8 A \leq {Z}_{r} < - 6 A λ ( {c}_{0} ) \approx ln \frac{exp [ - {( {Z}_{r} - A )}^{2} \text{/} 2 {σ}^{2} ]}{exp [ - {( {Z}_{r} + 7 A )}^{2} \text{/} 2 {σ}^{2} ]} = \frac{2 A}{{σ}^{2}} 4 ( {Z}_{r} + 3 A ) . & ( 10 ) \\ When - 6 A \leq {Z}_{r} < - 4 A λ ( {c}_{0} ) \approx ln \frac{exp [ - {( {Z}_{r} - A )}^{2} \text{/} 2 {σ}^{2} ]}{exp [ - {( {Z}_{r} + 5 A )}^{2} \text{/} 2 {σ}^{2} ]} = \frac{2 A}{{σ}^{2}} 3 ( {Z}_{r} + 2 A ) . & ( 11 ) \\ When - 4 A \leq {Z}_{r} < - 2 A λ ( {c}_{0} ) \approx ln \frac{exp [ - {( {Z}_{r} - A )}^{2} \text{/} 2 {σ}^{2} ]}{exp [ - {( {Z}_{r} + 3 A )}^{2} \text{/} 2 {σ}^{2} ]} = \frac{2 A}{{σ}^{2}} 2 ( {Z}_{r} + A ) . & ( 12 ) \\ When - 2 A \leq {Z}_{r} < 2 A λ ( {c}_{0} ) \approx ln \frac{exp [ - {( {Z}_{r} - A )}^{2} \text{/} 2 {σ}^{2} ]}{exp [ - {( {Z}_{r} + A )}^{2} \text{/} 2 {σ}^{2} ]} = \frac{2 A}{{σ}^{2}} ( {Z}_{r} ) . & ( 13 ) \\ When 2 A \leq {Z}_{r} < 4 A λ ( {c}_{0} ) \approx ln \frac{exp [ - {( {Z}_{r} - 3 A )}^{2} \text{/} 2 {σ}^{2} ]}{exp [ - {( {Z}_{r} + A )}^{2} \text{/} 2 {σ}^{2} ]} = \frac{2 A}{{σ}^{2}} 2 ( {Z}_{r} - A ) & ( 14 ) \\ When 4 A \leq {Z}_{r} < 6 A λ ( {c}_{0} ) \approx ln \frac{exp [ - {( {Z}_{r} - 5 A )}^{2} \text{/} 2 {σ}^{2} ]}{exp [ - {( {Z}_{r} + A )}^{2} \text{/} 2 {σ}^{2} ]} = \frac{2 A}{{σ}^{2}} 3 ( {Z}_{r} - 2 A ) & ( 15 ) \\ When 6 A \leq {Z}_{r} < 8 A λ ( {c}_{0} ) \approx ln \frac{exp [ - {( {Z}_{r} - 7 A )}^{2} \text{/} 2 {σ}^{2} ]}{exp [ - {( {Z}_{r} + A )}^{2} \text{/} 2 {σ}^{2} ]} = \frac{2 A}{{σ}^{2}} 4 ( {Z}_{r} - 3 A ) & ( 16 ) \\ When 8 A \leq {Z}_{r} < 10 A λ ( {c}_{0} ) \approx ln \frac{exp [ - {( {Z}_{r} - 9 A )}^{2} \text{/} 2 {σ}^{2} ]}{exp [ - {( {Z}_{r} + A )}^{2} \text{/} 2 {σ}^{2} ]} = \frac{2 A}{{σ}^{2}} 5 ( {Z}_{r} - 4 A ) & ( 17 ) \\ When 10 A \leq {Z}_{r} < 12 A λ ( {c}_{0} ) \approx ln \frac{exp [ - {( {Z}_{r} - 11 A )}^{2} \text{/} 2 {σ}^{2} ]}{exp [ - {( {Z}_{r} + A )}^{2} \text{/} 2 {σ}^{2} ]} = \frac{2 A}{{σ}^{2}} 6 ( {Z}_{r} - 5 A ) & ( 18 ) \\ When 12 A \leq {Z}_{r} < 14 A λ ( {c}_{0} ) \approx ln \frac{exp [ - {( {Z}_{r} - 13 A )}^{2} \text{/} 2 {σ}^{2} ]}{exp [ - {( {Z}_{r} + A )}^{2} \text{/} 2 {σ}^{2} ]} = \frac{2 A}{{σ}^{2}} 7 ( {Z}_{r} - 6 A ) & ( 19 ) \\ When {Z}_{r} \geq 14 A λ ( {c}_{0} ) \approx ln \frac{exp [ - {( {Z}_{r} - 15 A )}^{2} \text{/} 2 {σ}^{2} ]}{exp [ - {( {Z}_{r} + A )}^{2} \text{/} 2 {σ}^{2} ]} = \frac{2 A}{{σ}^{2}} 8 ( {Z}_{r} - 7 A ) & ( 20 )\end{matrix}$$

Since the common factor

$$\frac{2 A}{{σ}^{2}}$$

appears in all the above equations, without loss of generality, it can be neglected, which results in a more compact equation for λ(c₀) as follows:

$$λ ( {c}_{0} ) = \{ \begin{matrix}8 ( {Z}_{r} + 7 A ) , & {Z}_{r} < - 14 A \\ 7 ( {Z}_{r} + 6 A ) , & - 14 A \leq {Z}_{r} < - 12 A \\ 6 ( {Z}_{r} + 5 A ) , & - 12 A \leq {Z}_{r} < - 10 A \\ 5 ( {Z}_{r} + 4 A ) , & - 10 A \leq {Z}_{r} < - 8 A \\ 4 ( {Z}_{r} + 3 A ) , & - 8 A \leq {Z}_{r} < - 6 A \\ 3 ( {Z}_{r} + 2 A ) , & - 6 A \leq {Z}_{r} < - 14 A \\ 2 ( {Z}_{r} + A ) , & - 4 A \leq {Z}_{r} < - 2 A \\ {Z}_{r} , & - 2 A \leq {Z}_{r} < - + 2 A \\ 2 ( {Z}_{r} - A ) , & 2 A \leq {Z}_{r} < 4 A \\ 3 ( {Z}_{r} - 2 A ) , & 4 A \leq {Z}_{r} < 6 A \\ 4 ( {Z}_{r} - 3 A ) , & 6 A \leq {Z}_{r} < 8 A \\ 5 ( {Z}_{r} - 4 A ) , & 8 A \leq {Z}_{r} < 10 A \\ 6 ( {Z}_{r} - 5 A ) , & 10 A \leq {Z}_{r} < - 2 A \\ 7 ( {Z}_{r} - 6 A ) , & 12 A \leq {Z}_{r} < 14 A \\ 8 ( {Z}_{r} - 7 A ) , & {Z}_{r} \geq 14 A\end{matrix} . \qquad ( 21 )$$

In the exemplary embodiment described above, the piecewise function λ(c₀) has fifteen sub functions, where each sub function applies to a certain interval. In accordance with some embodiments, it can be further approximated to one linear function λ(c₀)=Zᵣ; LLR(c₀)=|Hₖ|² Zᵣ.

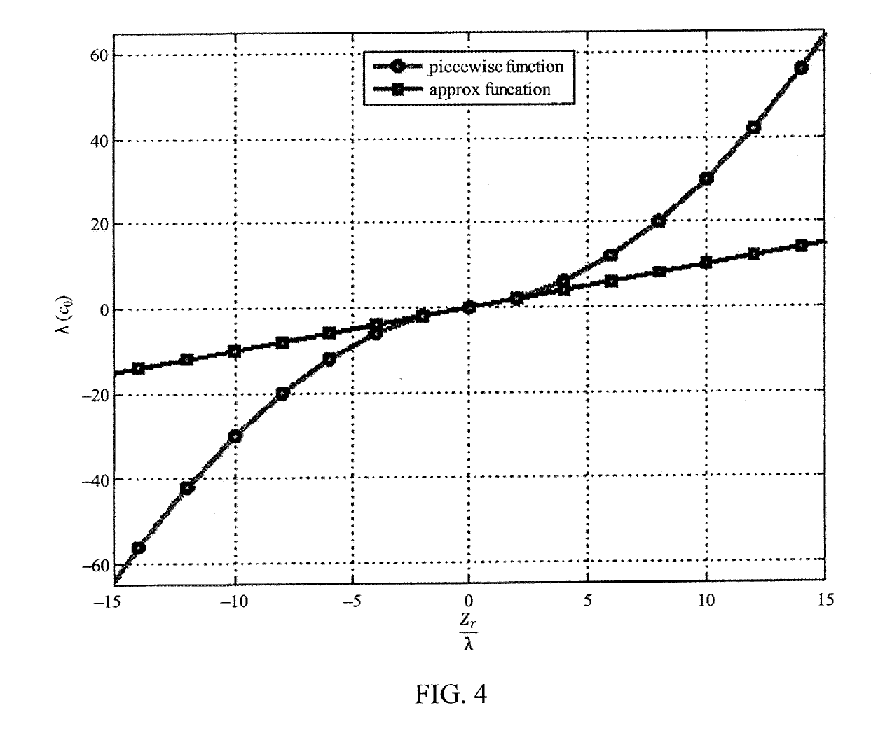

FIG. 4 illustrates graphs of an approximated function of λ(c₀) versus a piecewise function of λ(c₀). In accordance with some embodiments, following the same procedures discussed above, one can obtain LLR values of c₁, c₂, c₃ as follows:

λ(c₁)≈−|Zᵣ|+8A;

λ(c₂)≈−∥Zᵣ|−8A|+4A;

λ(c₃)≈−|∥Zᵣ|−8A|−4A|+2A;

LLR(cᵢ)=|Hₖ|² λ(cᵢ); i=1,2,3 (22)

To compare with LLR values of c₀, c₁, c₂, c₃ which are only in connection with the real part of the received complex symbol, the LLR values of c₄, c₅, c₆, c₇ are merely linked with the imaginary part of the received complex symbol. Performing the same work which is done with a one-dimensional mapping constellation, gives rise to the following equations:

λ(c₄)≈Zᵣ;

λ(c₅)≈−|Zᵢ|+8A;

λ(c₆)≈−∥Zᵢ|−8A|+4A;

λ(c₇)≈−|∥Zᵢ|−8A|−4A|+2A;

LLR(cᵢ)=|Hₖ|² λ(cᵢ); i=4,5,6,7. (23)

The developed algorithm was demonstrated in a MATLAB simulation. The outputs of the de-mapper are soft bits, which can be used by soft input decoders. In this simulation, the Viterbi decoder was selected. The adopted corresponding convolutional encoder has the polynomial generator (133, 171) and constraint length of 7. The FFT size of 1024 and a CP (cyclic prefix) length of 64 were used. The fading channel chosen was the one adopted by the IEEE 802.11 working group as follows:

hₖ=N(0, 0.5σₖ²)+jN(0, 0.5σₖ²);

σₖ²=σ₀² exp(−kTₛ/T_{RMS});

σ₀²=1−exp(−Tₛ/T_{RMS}), (24)

where hₖ is the complex channel gain of the k^{th} tap, T_{RMS} is the RMS delay spread of the channel, Tₛ is the sampling period, σ₀² was chosen so that the condition Σₖσₖ²−1 is satisfied to ensure a same average received power. The number of samples to be taken in the impulse response should ensure sufficient decay of the impulse response tail, e.g. kₘₐₓ=10×T_{RMS}/Tₛ. The RMS delay spread was set to be T_{RMS}=50 ns and the sampling rate was set to fₛ=1/Tₛ=100 MHz.

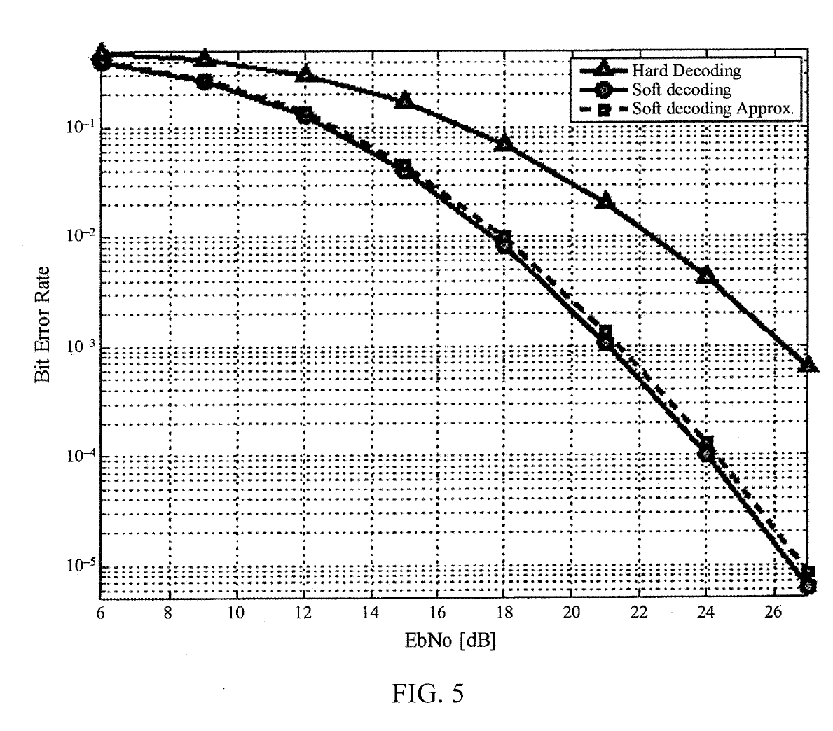

FIG. 5 shows the performance comparison of a hard demapper to that of the soft demapper for a 256-QAM system. The hard demapper is implemented by making a hard decision after equalization by equalizer 128 in FIG. 1. In some embodiments, the soft demapper 130 is implemented according to equations (22) and (23). In some embodiments, the performance improvement by the soft demapper 130 is 5 dB compared to the hard demapper. In accordance with various embodiments, the performance difference between the original demapper that uses the Max-Log-Map method and the proposed demapper can be negligible but the proposed demapper is much less complex than the original demapper. In various embodiments, the proposed soft demapper possesses a constant complexity that is much less complex than conventional demappers. Thus, the proposed demapper can be implemented and utilized much more efficiently and requires less processing power than conventional demappers.

While various embodiments of the invention have been described above, it should be understood that they have been presented by way of example only, and not of limitation. Likewise, the various diagrams may depict an example architectural or other configuration for the invention, which is done to aid in understanding the features and functionality that can be included in the invention. The present invention is not restricted to the illustrated example architectures or configurations, but can be implemented using a variety of alternative architectures and configurations. Additionally, although the invention is described above in terms of various exemplary embodiments and implementations, it should be understood that the various features and functionality described in one or more of the individual embodiments are not limited in their applicability to the particular embodiment with which they are described, but instead can be applied, alone or in some combination, to one or more of the other embodiments of the invention, whether or not such embodiments are described and whether or not such features are presented as being a part of a described embodiment. Thus the breadth and scope of the present invention should not be limited by any of the above-described exemplary embodiments.

One or more of the functions described in this document may be performed by one or more appropriately configured units. The term “unit” as used herein, refers to software that is stored on computer-readable media and executed by one or more processors, firmware, hardware, and any combination of these elements for performing the associated functions described herein. Additionally, for purpose of discussion, the various units may be discrete units; however, as would be apparent to one of ordinary skill in the art, two or more units may be combined to form a single unit that performs the associated functions according embodiments of the invention.

Additionally, one or more of the functions described in this document may be performed by means of computer program code that is stored in a “computer program product,” “computer-readable medium,” and the like, which is used herein to generally refer to media such as, memory storage devices, or storage unit. These, and other forms of computer-readable media, may be involved in storing one or more instructions for use by processor to cause the processor to perform specified operations. Such instructions, generally referred to as “computer program code” (which may be grouped in the form of computer programs or other groupings), which when executed, enable the computing system to perform the desired operations.

It will be appreciated that, for clarity purposes, the above description has described embodiments of the invention which can be implemented with one or more functional units and/or processors. However, it will be apparent that any suitable distribution of functionality between different functional units, processors or domains may be used without detracting from the invention. For example, functionality illustrated to be performed by separate units, processors or controllers may be performed by the same unit, processor or controller. Hence, references to specific functional units are only to be seen as references to suitable means for providing the described functionality, rather than indicative of a strict logical or physical structure or organization.

What is claimed is:

1. A system for demodulating high-order Quadrature Amplitude Modulation (QAM) signals, comprising:
a cyclic prefix (CP) removal unit for removing a CP from a received signal to provide a first intermediate signal, wherein the first intermediate signal comprises a plurality of bits;
a fast fourier transform (FFT) unit configured to convert the first intermediate signal into a frequency domain;
a soft de-mapper configured to derive a plurality of soft bits based on log-likelihood estimates of the plurality of bits, wherein the soft de-mapper derives each soft bit by using a single linear function to approximate each soft bit; and
a decoder configured to decode a signal derived from the soft de-mapper into information.

2. The system of claim 1 further comprising a parallel-to-serial (P/S) converter coupled between the FFT unit and the soft de-mapper, wherein the P/S converter is configured to convert the output of the FFT unit from a plurality of parallel bits to a serial bit stream.

3. The system of claim 2 further comprising an equalizer coupled between the P/S converter and the soft de-mapper, wherein the equalizer is configured to equalize the serial output of the P/S converter to mitigate a channel effect on the serial output.

4. The system of claim 1 further comprising a de-interleaver coupled between the soft de-mapper and the decoder, wherein the de-interleaver is configured to de-interleave the output of the soft de-mapper and provide de-interleaved soft estimates of the plurality of bits to the decoder.

5. The system of claim 1 wherein the plurality of soft bits comprise eight soft bits c₀, c₁, c₂, c₃, c₄, c₅, c₆ and c₇, wherein c₀, c₁, c₂ and c₃ are associated with a real part of a complex symbol and c₄, c₅, c₆ and c₇ are associated with an imaginary part of the complex symbol.

6. The system of claim 5 wherein the single linear function for soft bits c₀, c₁, c₂ and c₃ are provided as follows:
λ(c₀)=Zᵣ; LLR(c₀)=|Hₖ|² Zᵣ
λ(c₁)≈−|Zᵣ|+8A;
λ(c₂)≈−∥Zᵣ|−8A|+4A;
λ(c₃)≈−|∥Zᵣ|−8A|−4A|+2A;
LLR(cᵢ)=|Hₖ|² λ(cᵢ); i=1,2,3
wherein Zᵣ is the real part of Z(k), wherein Z(k)=Y(k)/H(k), Y(k) is the k^{th} sample of a received OFDM symbol, H(k) is the channel frequency response (CFR) at the k^{th} subcarrier, A is a constellation normalization factor, and LLR is a log likelihood ratio indicative of a confidence level of each respective soft bit c₀, c₁, c₂ and c₃.

7. The system of claim 6 wherein the single linear function for soft bits c₄, c₅, c₆ and c₇ are provided as follows:
λ(c₄)≈Zᵣ;
λ(c₅)≈−|Zᵢ|+8A;
λ(c₆)≈−∥Zᵢ|−8A|+4A;
λ(c₇)≈−|∥Zᵢ|−8A|−4A|+2A;
LLR(cᵢ)=|Hₖ|² λ(cᵢ); i=4,5,6,7.
wherein Zᵢ is the imaginary part of Z(k).

8. A method of demodulating high-order Quadrature Amplitude Modulation (QAM) signals, comprising:
removing a cyclic prefix (CP) from a received signal to provide a first intermediate signal, wherein the first intermediate signal comprises a plurality of bits;
converting the first intermediate signal into a frequency domain;
deriving a plurality of soft bits based on log-likelihood estimates of the plurality of bits, wherein each soft bit is derived by using a single linear function to approximate each soft bit; and
decoding a signal derived from the soft de-mapper into information.

9. The method of claim 1 further comprising converting the first intermediate signal from a plurality of parallel bits to a serial bit stream.

10. The method of claim 2 further comprising equalizing the serial bit stream to mitigate a channel effect on the serial bit stream.

11. The method of claim 1 further comprising de-interleaving the plurality of soft bits prior to decoding.

12. The method of claim 1 wherein the plurality of soft bits comprise eight soft bits c₀, c₁, c₂, c₃, c₄, c₅, c₆ and c₇, wherein c₀, c₁, c₂ and c₃ are associated with a real part of a complex symbol and c₄, c₅, c₆ and c₇ are associated with an imaginary part of the complex symbol.

13. The method of claim 12 wherein the single linear function for soft bits c₀, c₁, c₂ and c₃ are provided as follows:
λ(c₀)=Zᵣ; LLR(c₀)=|Hₖ|² Zᵣ
λ(c₁)≈−|Zᵣ|+8A;
λ(c₂)≈−∥Zᵣ|−8A|+4A;
λ(c₃)≈−|∥Zᵣ|−8A|−4A|+2A;
LLR(cᵢ)=|Hₖ|² λ(cᵢ); i=1,2,3
wherein Zᵣ is the real part of Z(k), wherein Z(k)=Y(k)/H(k), Y(k) is the k^{th} sample of a received OFDM symbol, H(k) is the channel frequency response (CFR) at the k^{th} subcarrier, A is a constellation normalization factor, and LLR is a log likelihood ratio indicative of a confidence level of each respective soft bit c₀, c₁, c₂ and c₃.

14. The method of claim 13 wherein the single linear function for soft bits c₄, c₅, c₆ and c₇ are provided as follows:
λ(c₄)≈Zᵣ;
λ(c₅)≈−|Zᵢ|+8A;
λ(c₆)≈−∥Zᵢ|−8A|+4A;
λ(c₇)≈−|∥Zᵢ|−8A|−4A|+2A;
LLR(cᵢ)=|Hₖ|² λ(cᵢ); i=4,5,6,7.
wherein Zᵢ is the imaginary part of Z(k).

15. A non-transitory computer-readable medium storing computer-executable instructions that when executed perform a method of demodulating high-order Quadrature Amplitude Modulation (QAM) signals, the method comprising:
removing a cyclic prefix (CP) from a received signal to provide a first intermediate signal, wherein the first intermediate signal comprises a plurality of bits;
converting the first intermediate signal into a frequency domain;
deriving a plurality of soft bits based on log-likelihood estimates of the plurality of bits, wherein each soft bit is derived by using a single linear function to approximate each soft bit; and
decoding a signal derived from the soft de-mapper into information.

16. The non-transitory computer-readable medium of claim 15, wherein the method further comprises converting the first intermediate signal from a plurality of parallel bits to a serial bit stream.

17. The non-transitory computer-readable medium of claim 15, wherein the method further comprises de-interleaving the plurality of soft bits prior to decoding.

18. The non-transitory computer-readable medium of claim 15, wherein the plurality of soft bits comprise eight soft bits c₀, c₂, c₃, c₄, c₅, c₆ and c₇, wherein c₀, c₁, c₂ and c₃ are associated with a real part of a complex symbol and c₄, c₅, c₆ and c₇ are associated with an imaginary part of the complex symbol.

19. The non-transitory computer-readable medium of claim 18 wherein the single linear function for soft bits c₀, c₁, c₂ and c₃ are provided as follows:
λ(c₀)=Zᵣ; LLR(c₀)=|Hₖ|² Zᵣ
λ(c₁)≈−|Zᵣ|+8A;
λ(c₂)≈−∥Zᵣ|−8A|+4A;
λ(c₃)≈−|∥Zᵣ|−8A|−4A|+2A;
LLR(cᵢ)=|Hₖ|² λ(cᵢ); i=1,2,3
wherein Zr is the real part of Z(k), wherein Z(k) =Y(k)/H(k), Y(k) is the k^{th} sample of a received OFDM symbol, H(k) is the channel frequency response (CFR) at the k^{th} subcarrier, A is a constellation normalization factor, and LLR is a log likelihood ratio indicative of a confidence level of each respective soft bit c₀, c₁, c₂ and c₃.

20. The non-transitory computer-readable medium of claim 18 wherein the single linear function for soft bits c₄, c₅, c₆ and c₇ are provided as follows:
λ(c₄)≈Zᵣ;
λ(c₅)≈−|Zᵢ|+8A;
λ(c₆)≈−∥Zᵢ|−8A|+4A;
λ(c₇)≈−|∥Zᵢ|−8A|−4A|+2A;
LLR(cᵢ)=|Hₖ|² λ(cᵢ); i=4,5,6,7.
wherein Zᵢ is the imaginary part of Z(k).
